(19) United States
(12) Patent Application Publication
(10) Pub. No.: US 2014/0204519 A1
(43) Pub. Date: Jul. 24, 2014

(54) ELECTRONIC DEVICE WITH DETACHABLE KEYBOARD

(71) Applicant: TIANJIN FUNAYUANCHUANG TECHNOLOGY CO.,LTD., Tianjin (CN)

(72) Inventor: HO-CHIEN WU, New Taipei (TW)

(73) Assignee: TIANJIN FUNAYUANCHUANG TECHNOLOGY CO.,LTD., Tianjin (CN)

(21) Appl. No.: 14/140,030

(22) Filed: Dec. 24, 2013

(30) Foreign Application Priority Data
Jan. 22, 2013 (CN) 2013100229872

(51) Int. Cl. G06F 1/16

(52) U.S. Cl. CPC G06F 1/1669
USPC 361/679.17

(57) ABSTRACT

An electronic device includes a base and a keyboard. The base includes a working surface and defines a receiving space. The keyboard includes a top side and a bottom side opposite to the top side. A plurality of key is mounted on the top side. A function module is mounted on the bottom side. The keyboard can be alternatively mounted in the receiving space in a first direction or in a second direction. The plurality of keys is accessible from the working surface when the keyboard is mounted in the receiving space in a first direction, and the function module is accessible from the working space when the keyboard is mounted in the receiving space in a second direction.

### BACKGROUND

1. Technical Field

The disclosure generally relates to electronic devices, and more particularly to an electronic device which has a detachable keyboard.

2. Description of Related Art

Electronic devices, such as notebook computers, are widely used. The notebook computers are often equipped with a keyboard for inputting information. The keyboard is secured on the notebook computer. When the keyboard needs to be replaced, it may be inconvenient to detach the keyboard.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of an electronic device.

FIG. 2 is another exploded, isometric view of the electronic device of FIG. 1.

FIG. 3 is an assembled view of the electronic device of FIG. 1.

FIG. 4 is an enlarged view of the circle portion IV of FIG. 3.

FIG. 5 is a partial assembled view of the electronic device of FIG. 1.

FIG. 6 is another partial assembled view of the electronic device of FIG. 1.

FIG. 7 is another assembled view of the electronic device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

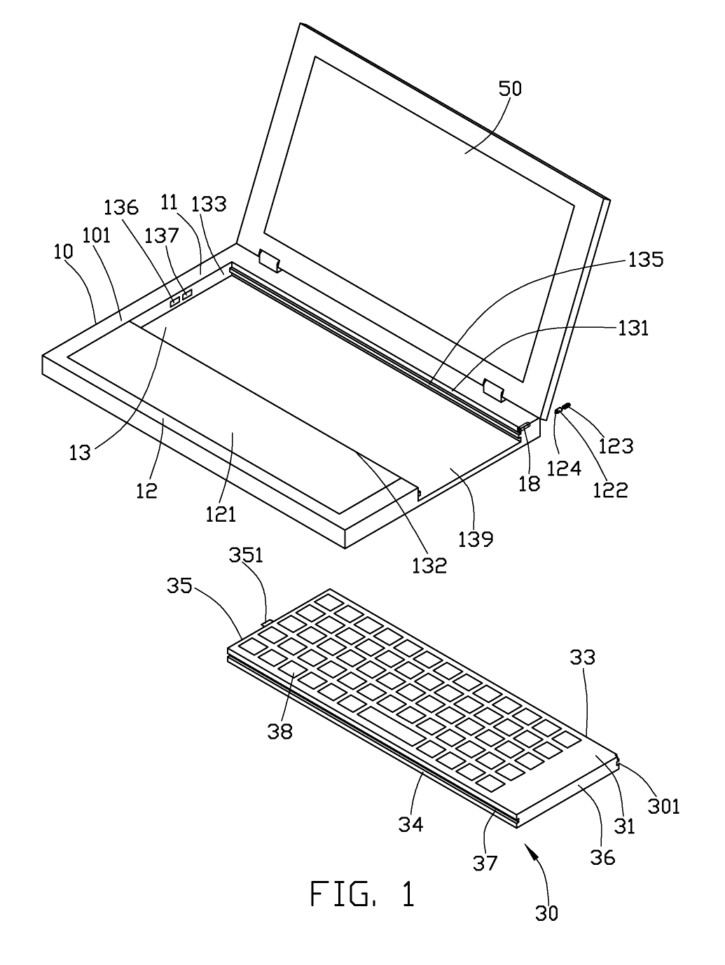

FIG. 1 shows one embodiment of an electronic device. The electronic device includes a base 10, a keyboard 30, and a display apparatus 50. The display apparatus 50 is pivotally mounted on the base 10. In one embodiment, the electronic device is a notebook computer.

The base 10 includes a working surface 101. The working surface 101 includes a first area 11 and a second area 12. The first area 11 is located adjacent the display apparatus 50. The first area 11 is sunk to define a receiving space 13, which is adapted to receive the keyboard 30. The base 10 includes a front edge 131, a rear edge 132 and a side edge 133. The front edge 131, the rear edge 132, and the side edge 133 together surround the receiving space 13. The receiving space 13 defines an opening 139 which communicates to an outside of the base 10. The front edge 131 is parallel to the rear edge 132. The side edge 133 is perpendicularly connected between the front edge 131 and the rear edge 132. A pair of sliding rails 135 is formed on the front edge 131 and the rear edge 132. The side edge 133 defines a first port 136 and second port 137.

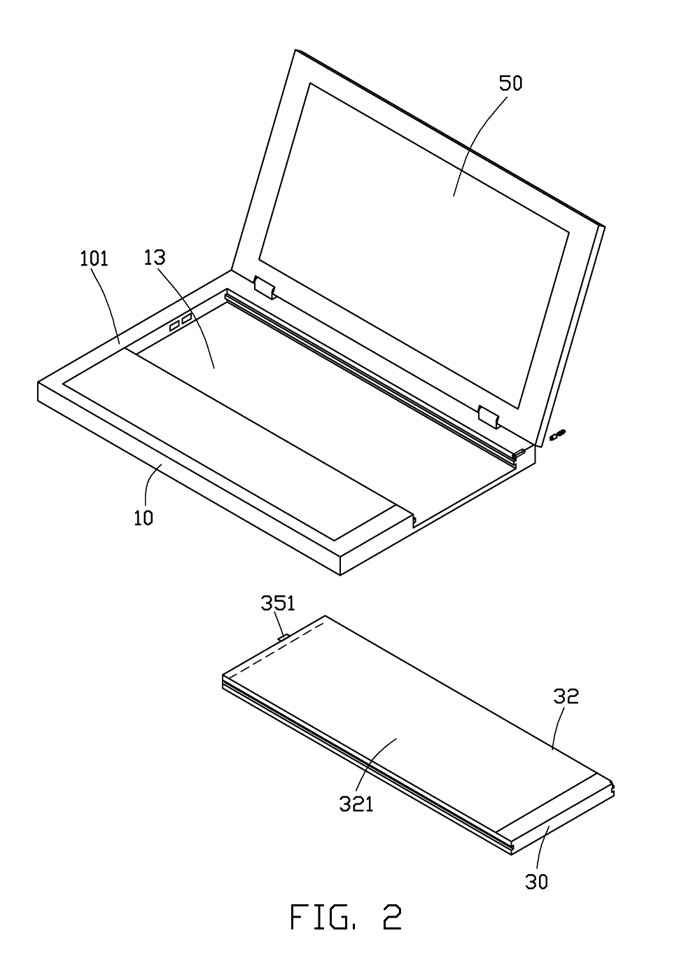

FIGS. 1 and 2 show that the keyboard 30 is substantially a cube. The keyboard 30 includes a top side 31, a bottom side 32, a front side 33, a rear side 34, a left side 35 and a right side 36. The top side 31 is parallel to the bottom side 32. The front side 33 is parallel to the rear side 34. The left side 35 is parallel to the right side 36. A plurality of keys 38 are mounted on the top side 31. A function module 321 is mounted on the bottom side 32. The function module 321 has a different function relative to the plurality of keys 38. In one embodiment, the function module 321 is a touch screen. A pair of sliding grooves 37 is defined on the front side 33 and the rear side 34. A keyboard connector 351 is secured on the left side 35. The keyboard connector 351 can insert in the first port 136 when the top side 31 is located above the bottom side 32. After the keyboard 30 rotates 180 degrees to have the bottom side 32 positioned above the top side 31, the keyboard connector 351 can insert in the second port 137. The keyboard 30 defines a cutout 301 at a connection portion of the front side 33 and the right side 36.

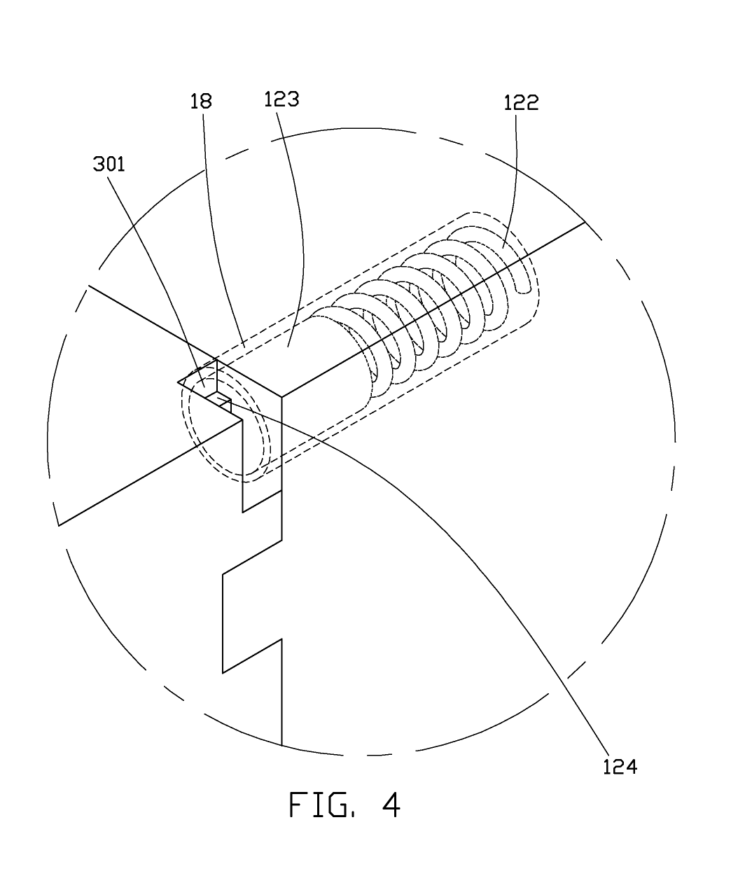

FIGS. 1 and 4 show that the base 10 defines a receiving hole 18 aligned to the opening 139. A spring 122 and a positioning pillar 123 can be located in the receiving hole 18. A blocking piece 124 is mounted on a distal end of the positioning pillar 123. One end of the spring 122 is secured on another distal end of the positioning pillar 123. Another end of the positioning pillar 123 abuts a bottom of the receiving hole 18. When the spring 122 is in a natural state, the blocking piece 124 is located out of the receiving hole 18 and located in the opening 139. When the spring 122 is elastically deformed, the blocking piece 124 is moved in the receiving hole 18.

The second area 12 includes a touch screen 121 mounted thereon.

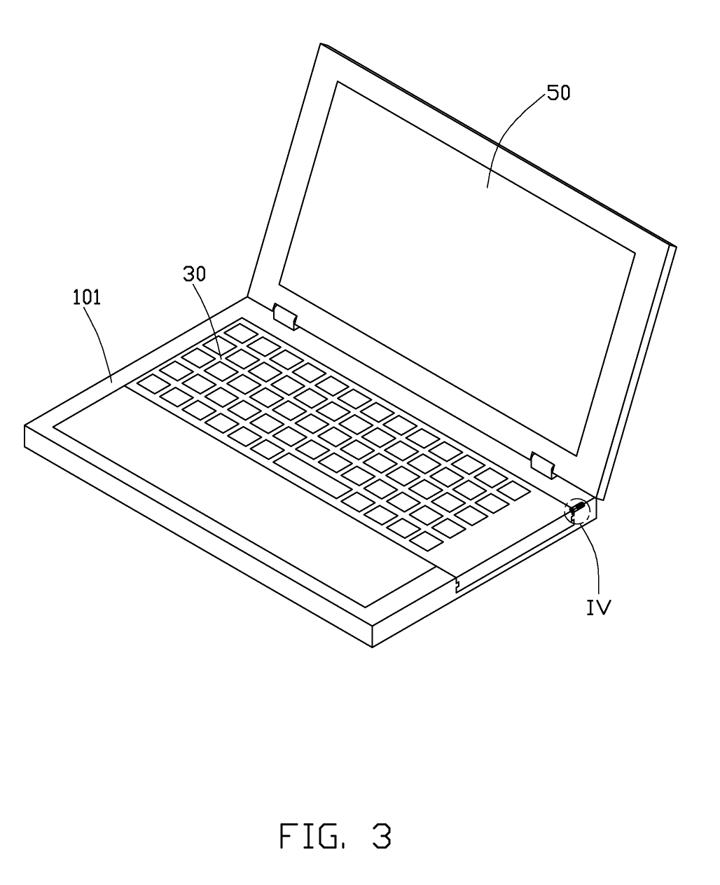

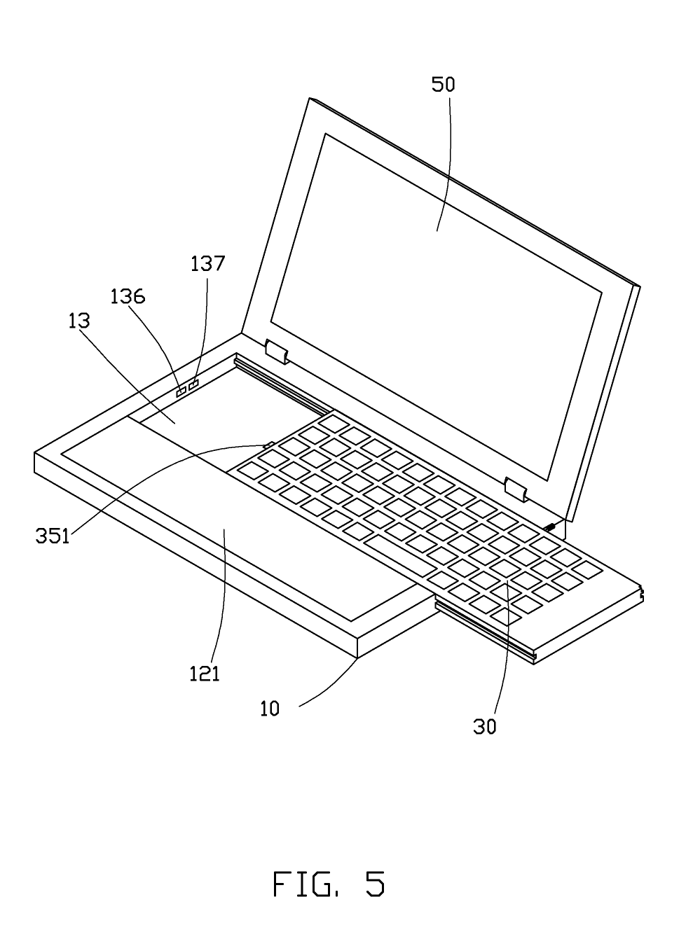

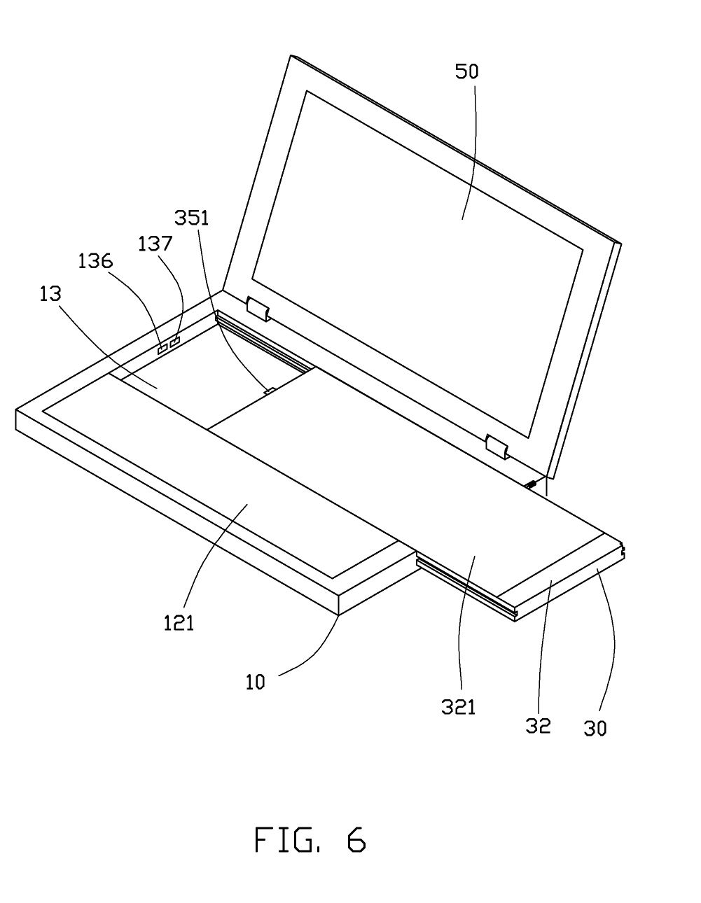

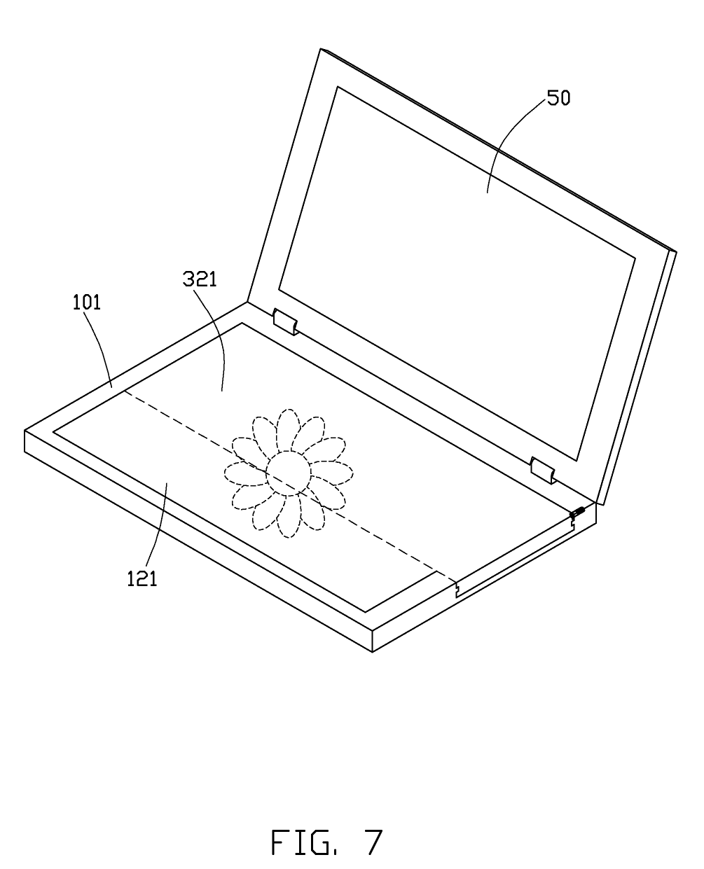

FIGS. 1 to 7 show that in assembly, the blocking piece 124 is moved in the receiving hole 18 to elastically deform the spring 122. The top side 31 of the keyboard 30 is located above the bottom side 32. The keyboard 30 is moved in the receiving space 13 via the opening 139. The pair of sliding rails 135 of the base 10 slide in the pair of the sliding grooves 37 of the keyboard 30. The front side 33 of the keyboard 30 presses the blocking piece 124 to keep the blocking piece 124 in the receiving hole 18. The keyboard 30 slides into the receiving space 13 until the keyboard connector 351 is inserted in the first port 136. At this position, the front side 33 is misaligned to the blocking piece 124. The blocking piece 124 is moved out of the receiving hole 18 and inserted in the cutout 301 under an elastic force of the spring 122 to block the keyboard 30. Thereby, the keyboard 30 is prevented from sliding out of the receiving space 13. The keyboard 30 is mounted in the base 10 with the keys 38 exposing on the working surface 101.

To detach the keyboard 30, the blocking piece 124 slides back to the receiving space 13. The blocking piece 124 does not block the keyboard 30. The keyboard 30 slides out of the receiving space 13 to be detached from the base 10. In another embodiment, the keyboard 30 is a wireless keyboard. The detached keyboard 30 can be placed on any position to be used conveniently.

The keyboard 30 also can be rotate 180 degrees to have the bottom side 32 located above the top side 31. The blocking piece 124 is moved in the receiving hole 18 to elastically deform the spring 122. The keyboard 30 is moved in the receiving space 13 via the opening 139. The pair of sliding rails 135 of the base 10 engages in the pair of the sliding grooves 37 of the keyboard 30. The front side 33 of the keyboard 30 presses the blocking piece 124 to keep the blocking piece 124 in the receiving hole 18. The keyboard 30 slides into the receiving space 13 until the keyboard connector 351 is inserted in the second port 137. At this position, the front side 33 is misaligned to the blocking piece 124. The blocking piece 124 is moved out of the receiving hole 18 and is inserted in the cutout 301 under an elastic force of the spring 122 to block the keyboard 30. Thereby, the keyboard 30 is prevented from sliding out of the receiving space 13. The keyboard 30 is mounted in the base 10 with the function module 321 exposed on the working surface 101 and coplanar with the touch screen 121. The touch screen of the function module 321 is aligned to the touch screen 121 to combine a large touch screen.

Therefore, the large touch screen is conveniently operated, such as depicted in FIG. 1. In another embodiment, the function module 321 is a normal screen, which only shows information and cannot receive touch input.

In another embodiment, the first port 136 and the second port 137 can be combined to a compatible connector, which can receive the keyboard connector 351 in two directions. For example, the compatible connector can be a Lighting connector used by Apple. The compatible connector is set on a middle portion of the side edge 133. The keyboard connector 351 can be inserted in the compatible connector in a direct direction or an inverse direction.

In another embodiment, the slide rail 135 is set on the keyboard 30, and the slide groove 37 is defined in the base 10.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. An electronic device, comprising:
a base comprising a working surface and defining a receiving space; and
a keyboard comprising a top side and a bottom side opposite to the top side, a plurality of keys mounted on the top side, and a function module mounted on the bottom side, wherein the keyboard is configured to be mounted in the receiving space in a first direction or in a second direction; when the keyboard is mounted in the receiving space in the first direction, the plurality of keys is accessible from the working surface; and when the keyboard is mounted in the receiving space in the second direction, the function module is accessible from the working space.

2. The electronic device of claim 1, wherein a slide rail is formed in one of the receiving space and the keyboard, and a sliding groove is defined in another one of the receiving space and the keyboard, and the keyboard is movably received in the receiving space by sliding the slide rail into the sliding groove.

3. The electronic device of claim 1, wherein the receiving space defines an opening accessible from out of the base, and the keyboard is configured to be moved in the receiving space via the opening.

4. The electronic device of claim 3, wherein the base defines a receiving hole, the receiving hole is aligned with the opening; a positioning pillar is slidably mounted in the receiving hole, a blocking piece is mounted on a distal end of the positioning pillar, and the positioning pillar is configured to slide in the receiving hole to prevent the keyboard from sliding out of the receiving space by placing the blocking piece in the opening.

5. The electronic device of claim 4, wherein the keyboard defines a cutout, and the positioning pillar is configured to be inserted into the cutout.

6. The electronic device of claim 5, wherein another distal end of the positioning pillar is connected to a spring, the spring abuts a bottom of the receiving hole, the blocking piece is located out of the receiving hole when the spring is not compressed, and the blocking piece is moved into the receiving hole when the spring is compressed.

7. The electronic device of claim 1, wherein the keyboard comprises a keyboard connector, the base defines a first port and a second port in the receiving space, and the keyboard connector is configured to be inserted into the first port when the plurality of keys are accessible from the working surface, and the keyboard connector is configured to be inserted into the second port when the function module is accessible from the working surface.

8. The electronic device of claim 1, where the base comprises a compatible connector, the keyboard comprises a keyboard connector, and the compatible connector is configured to connect to the keyboard connector in a direct direction or an inverse direction.

9. The electronic device of claim 1, wherein the keyboard is a wireless keyboard.

10. An electronic device, comprising:
a base defining a receiving space, the receiving space comprising an opening accessible from out of the base;
a keyboard movably received in the receiving space via the opening.

11. The electronic device of claim 10, wherein a slide rail is formed in one of the receiving space and the keyboard, and a sliding groove is defined in another one of the receiving space and the keyboard, and keyboard is movably received in the receiving space by sliding the slide rail into the sliding groove.

12. The electronic device of claim 10, wherein the base defines a receiving hole, the receiving hole is aligned with the opening; a positioning pillar is slidably mounted in the receiving hole, a blocking piece is mounted on a distal end of the positioning pillar, and the positioning pillar is configured to slide in the receiving hole to prevent the keyboard from sliding out of the receiving space by placing the blocking piece in the opening.

13. The electronic device of claim 12, wherein the keyboard defines a cutout, and the positioning pillar is configured to be inserted into the cutout.

14. The electronic device of claim 13, wherein another distal end of the positioning pillar is connected to a spring, the spring abuts a bottom of the receiving hole, the blocking piece is located out of the receiving hole when the spring is not compressed, and the blocking piece is moved into the receiving hole when the spring is compressed.

15. The electronic device of claim 10, wherein the keyboard comprises a top side, a plurality of keys are mounted on the top side, the keyboard comprises a keyboard connector; the base comprises a working surface, the base defines a first port in the receiving space, and the keyboard connector is configured to be inserted into the first port when the plurality of keys are accessible from the working surface.

16. The electronic device of claim 15, wherein the keyboard comprises a bottom side opposite to the top side, a function module is mounted on the bottom side, the base defines a second port in the receiving space, and the keyboard connector is configured to be inserted into the second port when the function module is accessible from the working surface.

17. The electronic device of claim 16, wherein the function module is a screen.

18. The electronic device of claim 17, wherein the screen is a first touch screen, the base comprises a second touch screen, and the first touch screen and the second touch screen are configured to be combined into one touch screen when the function module is accessible from the working surface.

19. The electronic device of claim 10, where the base comprises a compatible connector, the keyboard comprises a keyboard connector, and the compatible connector is configured to connect to the keyboard connector in a direct direction or an inverse direction.

20. The electronic device of claim 10, wherein the keyboard is a wireless keyboard.
